(19) United States
(12) Patent Application Publication
(10) Pub. No.: US 2021/0097467 A1
(43) Pub. Date: Apr. 1, 2021

(54) RISK-CONTROLLED OPERATIONS COST PERFORMANCE MODELING AND ASSOCIATED SYSTEMS AND METHODS

(71) Applicant: Kohl's, Inc., Menomonee Falls, WI (US)

(72) Inventors: Zhiyu Liang, San Jose, CA (US); Alan Lee, Sunnyvale, CA (US); Jinge Zhang, San Ramon, CA (US); Ragnar H. Lesch, Fremont, CA (US); Yepeng Sun, Fremont, CA (US)

(21) Appl. No.: 17/037,348

(22) Filed: Sep. 29, 2020

Related U.S. Application Data
(60) Provisional application No. 62/908,444, filed on Sep. 30, 2019.

(51) Int. Cl. G06Q 10/06; G06Q 10/10; G06Q 20/20; G06Q 40/00; G06Q 10/04

(52) U.S. Cl. CPC G06Q 10/06375; G06Q 10/0635; G06Q 10/0639; G06Q 10/067; G06Q 20/202; G06Q 40/125; G06Q 10/04; G06Q 10/109

(57) ABSTRACT

Risk-controlled operations cost performance modeling and associated systems and methods are disclosed herein. A retail store generates operations data and performance data, where the operations data represents values of an operations parameter collected over a period of time from the retail store and the performance data represents a value of a performance parameter measured for each of the values of the operations data. Based on the operations and performance data, an initial relationship model is generated. A confidence interval for the initial relationship model is generated using intermediate relationship models, generated by subsampling the operations and performance data. The confidence interval is used to select an operations threshold, which modifies the initial relationship model to generate a risk-controlled relationship model. The risk-controlled relationship model is used to select a value of the operations parameter for use in the retail environment to achieve a desired performance value.

### CROSS-REFERENCE TO RELATED APPLICATION(S)

This application claims the benefit of U.S. Provisional Application No. 62/908,444, filed Sep. 30, 2019, which is incorporated herein by reference in its entirety.

### TECHNICAL FIELD

This disclosure relates generally to predicting performance based on operations parameters using a risk-controlled model.

### BACKGROUND

Many types of businesses adjust parameters associated with their operations in order to achieve performance targets. For example, a retail store may adjust operations parameters to achieve performance targets, such as revenue, foot traffic, transaction volume, or transaction amount. These operations parameters may include the number of employees working in the store at a given time, the types of employees working in the store at a given time, the number of labor hours by the employees over a specified time period, or the store's operating hours.

To predict a value of the operations parameter that will achieve a particular performance metric at a given time, some businesses use models that relate historical operations parameters to corresponding measured performance values. However, existing models do not take into account varying levels of risk associated with different values of the operations parameters. For example, increasing the number of employees working in a retail store at a given time may have increasing levels of risk as the number of employees increases. This is because the amount of performance data available for extraordinarily high numbers of employees (e.g., during peak holiday hours) may be significantly lower than the amount of data available for other values of the operations parameter. As the number of employees working at a given time increases, the cost to pay the employees increases with each added employee, but the performance of the store may not increase with the added employees or may not increase as much as the cost of the labor hours. This reality may not be adequately represented in the model in a manner that accurately conveys the risk associated with the increased employee numbers.

### BRIEF DESCRIPTION OF THE DRAWINGS

FIG. 1 is a system diagram illustrating an example of a computing environment in which a performance optimization system operates.

FIG. 2 is a flowchart diagram illustrating a process to generate a risk-controlled relationship model based on performance data and operations data in accordance with embodiments of the present technology.

FIG. 3 is a block diagram showing components typically incorporated in at least some of the computer systems and other devices on which the performance optimization system operates.

FIG. 4 is a flow diagram showing a process to generate an initial relationship model in accordance with embodiments of the present technology.

FIG. 5 illustrates a plot visualization of a relationship model.

FIG. 6 is a flow diagram showing a process to generate a risk-controlled relationship model in accordance with embodiments of the present technology.

FIG. 7 is a plot diagram illustrating the multiple relationship models generated based on subsampling.

FIG. 8A is a plot diagram illustrating an initial relationship model superimposed with an operations threshold.

FIG. 8B is a plot diagram illustrating a modified relationship model.

FIG. 8C is a plot diagram illustrating a plurality of a relationship models associated with different locations.

### DETAILED DESCRIPTION

The present technology is directed to systems and methods including risk-controlled operations-cost performance modeling. A risk-controlled relationship model accounts for the risks associated with increasing operations parameters associated with a business, while otherwise enabling the business to predict performance that will be achieved for a given value of the operations parameter. For example, the risk-controlled relationship model predicts a relationship between operations parameter of a retail store (such as a number of employees working at a given time) and performance of the store resulting from the operations parameters (such as total sales).

In some embodiments, a retail store generates operations data and performance data, where the operations data represents a plurality of values of an operations parameter collected over a period of time from the retail store and the performance data represents a value of a performance parameter measured for each of the plurality of values of the operations data. Based on the operations and performance data, an initial relationship model is generated. A confidence interval for the initial relationship model is generated using intermediate relationship models, generated by subsampling the operations and performance data. The confidence interval is used to select an operations threshold, which modifies the initial relationship model to generate a risk-controlled relationship model. The risk-controlled relationship model is used to select a value of the operations parameter for use in the retail store to achieve a desired performance value.

In some embodiments, a non-transitory computer readable storage medium stores executable computer program instructions that when executed by a processor cause the processor to access sets of operations data and performance data. The processor generates, based on the sets of operations data and performance data, an initial relationship model predicting a performance metric across a range of operations parameters. Multiple intermediate relationship models are generated using each of multiple subsamples of the operations data and the performance data, and a confidence interval is generated based on a comparison between the initial relationship model and the plurality of intermediate relationship models. The processor selects an operations threshold using the confidence interval, and generates a risk-controlled relationship model based on the initial relationship model and the operations threshold.

In some embodiments, a system comprises a database and a performance optimization system. The database stores operations data and performance data. The performance optimization system is communicatively coupled to the database and configured to apply a risk-controlled relationship model to select an operations parameter for a retail store, where the risk-controlled relationship model is generated based on the operations data and the performance data and represents a relationship between the operations data and the performance data for values of the operations data that are below an upper threshold. The upper threshold is selected based on a confidence interval associated with the operations data and the performance data.

### Embodiments of Performance Optimization Systems

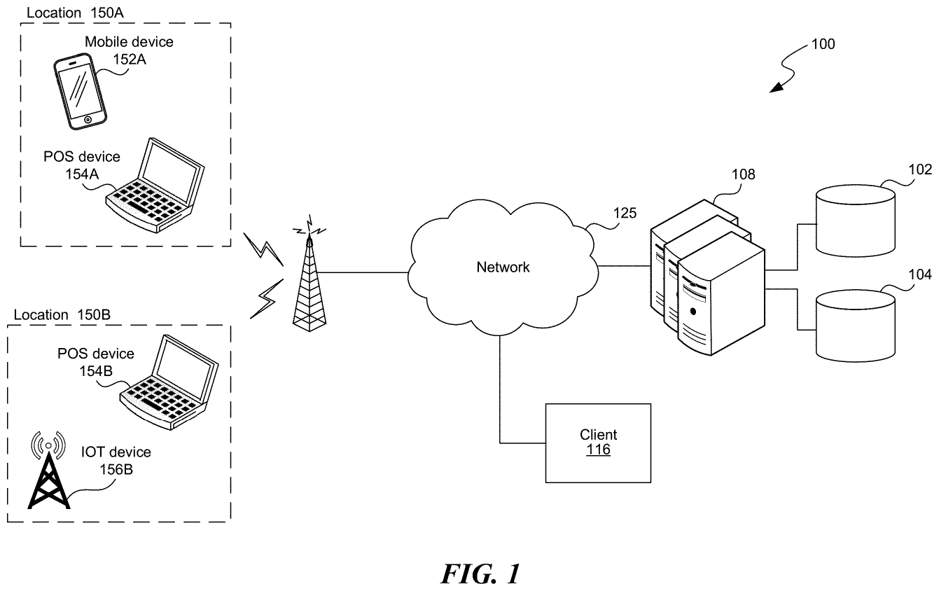

FIG. 1 is a system diagram illustrating an example of a performance optimization system 100, according to some implementations. The performance optimization system 100 includes computing device 108 (also referred to as a “computing system 108”), one or more client devices 116, a performance database 102, and an operations database 104. The optimization system 100 communicates with devices associated with any number of physical locations 150, such as retail stores, warehouses, or other types of businesses or organizations with physical locations that rely upon physical resources.

As shown in FIG. 1, various computing devices can be associated with the physical locations 150, including a mobile device 152A, point of sale (POS) devices 154, and Internet of Things (IOT) device 156B. Each location 150 can be associated with any combination of such devices. In the example of FIG. 1, a first location 150A has the mobile device 152A and the POS device 154A, while a second location 150B has the POS device 154B and the IOT device 156B. However, each location may include multiple devices of each type, a single device, or different combinations of devices.

The mobile device 152A includes a device used on the premises of the location 150 by a person associated with the business. In some cases, the mobile device 152A is a device used by a manger of the location's business and includes a worker scheduling application, storing schedules and timesheets associated with workers. In some implementations, mobile device 152 can include a workload management application, tracking the tasks (e.g., cleaning tasks, stocking tasks) and assignments (e.g., greeter, cashier) associated with a worker. In other cases, the mobile device 152A is a device carried by a worker as the worker works at the location 150. In these cases, the mobile device 152A can include one or more sensors for measuring information about the worker's work, an application for the worker to track the work, or both. For example, locations of workers inside the physical location 150 can be identified based on the mobile device 152A (e.g., via a GPS sensor in the mobile device, or by triangulating WiFi or RFID signals transmitted from the mobile device).

The POS device 154 processes purchase transactions associated with the location 150. When a customer completes a purchase, the POS device 154 can capture data such as identifiers of the purchased products or services, the time of the purchase, the number or total cost of purchased items, an identifier of the customer making the purchase, an identifier of an employee assisting the customer to make the purchase, or other such information. In various implementations, the POS device 154 can be dedicated terminal within the location 150, an application executed by the mobile device 152, or an application executed by a mobile device associated with the customer making the purchase.

The IOT device 156B can include any device within the location 150 that is configured to capture data indicating a status of the location. Example types of IOT devices 154 include cameras, motion-sensing lighting systems, air systems, RFID readers, WiFi detectors, or any other device that may measure or detect people, devices, or objects located in or near the physical location 150.

Computing device 108 is configured to retrieve performance and operations data from multiple locations 150, using network 125. Network 125 can be a local area network (LAN), a wide area network (WAN), or other wired or wireless networks. In some implementations, network 125 is the Internet or some other public or private network. Various client computing devices, including, for example, the client device 116, POS devices 152, or IOT devices 154, are connected to network 125 through a network interface, such as by wired or wireless communication. The connection between computing device 108 and network 125 can be any kind of local, wide area, wired, or wireless network.

The performance optimization system 100 further includes the performance database 102, storing performance data associated with the physical locations 150. Performance data can include measured values associated with any performance parameter of the location's business. If the location 150 is a retail store, example types of performance parameters that are associated with the store includes revenue, conversions, profits, transaction volume, or average transaction amount, and the performance data includes values representing measurements of these performance parameters at a given time. Performance data stored in the performance database 102 can further include activity or engagement metrics. For example, the performance data can include a number of people that entered a location, or a number of people that interacted with an employee. Performance data can be segmented based on time periods (e.g., daily, hourly, weekly, quarterly, monthly).

In some embodiments, the performance data is retrieved from the point of sale (“POS”) device 154 at location 150. The performance data can be retrieved by the computing device 108, another device, or directly added to the performance database 102 by the POS device 154. For example, POS device 154 can generate payment transactions, and computing device 108 can be configured to retrieve aggregate revenue data from POS device 154. The performance data can be stored in the database 102 in association with an identifier of the physical location 150 from which it was retrieved, as well as a time over which the data was collected. The identifier of the physical location 150 can include coordinates (e.g., latitude and longitude), address, location identifier, contact number, other identifying information.

The performance data in the performance database 102 can originate from sources other than or additional to the POS devices 154. In some implementations, performance data relates to actions performed by consumers on a website, such as customer conversions or number of pages visited, and the performance data in the performance database 102 is generated by an ecommerce analytics computing device. In yet another implementation, performance data such as billable hours or sales volume is retrieved from external databases such as accounting databases, customer relationship management (CRM) systems, or sale order databases.

The operations database 104 stores operations data associated with the physical locations 150. The operations data includes measured values associated with any operations parameter of a location's business, or the physical or human resources used to operate the business. For example, operations parameters associated with a retail store can include labor hours, operation hours, staffing headcount, staffing headcount or hours per job type (e.g., a number of stockroom employees, or a number of point-of-sale employees), staffing headcount or hours per employee type (e.g., seasonal vs. full-time), or employee hours per shift. For example, operations data can include daily labor hours (e.g., total hours worked across employees) for a set of days. As another example, operations data can include, for a set of days, the number of employees that worked on each day. Operations data, generally, represents a controllable parameter (e.g., an independent variable) associated with a cost or limited resource, potentially corresponding to performance data (e.g., a dependent variable).

In some embodiments, the operations data for a location 150 is retrieved from a computing device associated with the location, such as the mobile device 152 or IOT device 156. For example, operations data such as labor hours, worker schedules, or worker timesheets is uploaded to the operations database 104 from the mobile device 152A. The mobile device 152A may further track more granular operations parameters such as tasks completed by a given worker, time spent by a worker on certain tasks, or time spent on certain assignments. If the mobile device 152A is a device carried by a worker while working at the location 150, the operations data retrieved from the mobile device can further include information such as the amount of time the worker was located in a given section of the location 150 during a shift or the distance the worker walked during a shift. As other examples, operations data generated based on data captured by IOT devices 156 in a location 150 include energy usage data within the location 150, number of workers at a particular store location, busyness of workers, cleanliness of store locations, or amount of merchandise on shelves compared to the amount in a stockroom.

In various implementations, the performance database 102 and the operations database 104 can be contained in a common database or separate databases. Though the performance database 102 and operations database 104 are displayed logically as single units, any database system can be implemented by computing device 108 to store this data. The database system can be a distributed computing environment encompassing multiple computing devices, can be located with computing device 108, or can be located at a geographically disparate physical location.

The computing device 108 uses data stored in the performance database 102 and the operations database 104 to generate risk-controlled relationship models for each location 150. The computing device 108 can output the risk-controlled relationship models for use in selecting values for operations parameters at the locations 150. In some cases, the computing device 108 generates interactive visualizations of the risk-controlled relationship models. Furthermore, some embodiments of the computing device 108 communicate with devices associated with the locations 150, such as the mobile device 152, the POS device 154, or the IOT device 156, to retrieve the operations and performance data and store the data in the respective databases. The computing device 108 can be an edge server which receives client requests and coordinates fulfillment of those requests through other servers. Though computing device 108 is displayed logically as a single server, computing device 108 can be a distributed computing environment encompassing multiple computing devices located at the same or at geographically disparate physical locations. In some implementations, computing device 108 corresponds to a group of servers.

The client device 116 is a user computing device used by a person associated with one or more of the locations 150. For example, the client device 116 can be used by a manager of the business at the location 150 to interact with the risk-controlled relationship model and determine operations parameters for the business based on the model. The client device 116 can display a visual representation of the risk-controlled relationship model generated by the computing device 108. For example, the computing device 108 can provide a web application interface to select or view the visualization of the model, which the client device 116 can access and render for display to a user. The computing device 108 can instead transmit the visual representation of the model to the client device 116 for display, such as via an email message or a web application programming interface (API). Furthermore, the client device 116 can be configured to use the risk-controlled relationship model generated by the computing device 108 to select a value for an operations parameter at a future time to achieve a specified performance metric. To select the value of the operations parameter, the client device 116 can calculate a cost to achieve various values of the operations parameter, and uses the risk-controlled relationship model to select an operations parameter that is expected to cause a performance value that exceeds the cost. For example, if the operations parameter is labor hours in a given week and the performance parameter is expected sales, the client device 116 uses the risk-controlled model to identify a number of labor hours for which the expected sales at least exceed the cost of the labor hours.

FIG. 1 and the discussion herein provide a brief, general description of a suitable computing environment in which the performance optimization system 100 can be supported and implemented. Although not required, aspects of the optimization system 100 are described in the general context of computer-executable instructions, such as routines executed by a computer, e.g., mobile device, a server computer, or personal computer. The system can be practiced with other communications, data processing, or computer system configurations, including: Internet appliances, hand-held devices (including tablet computers and/or personal digital assistants (PDAs)), Internet of Things (IoT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through any communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In an alternative implementation, the mobile device or portable device can represent the server portion, while the server can represent the client portion.

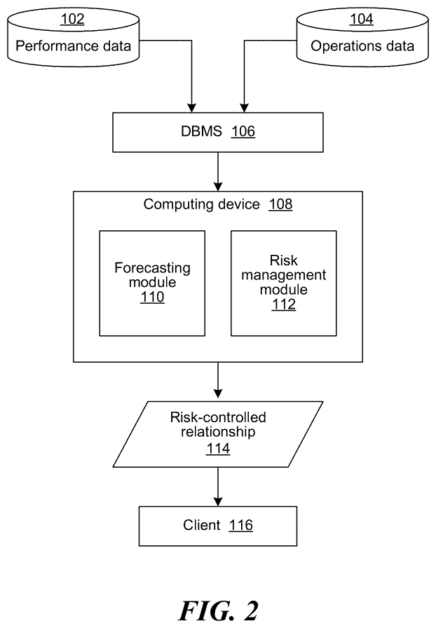

FIG. 2 is a flowchart diagram illustrating a data flow for the computing device 108 to generate a risk-controlled relationship model (RCRM) 114 based on performance data and operations data, according to some embodiments.

As shown in FIG. 2, the computing device 108 retrieves performance data and operations data from the performance database 102 and the operations database 104, respectively. Performance database 102 and operations database 104 can store data including historical data associated with a given location 150. In some embodiments, the computing device is configured to retrieve real-time data directly from data sources, such as POS computing device 154A instead of or in addition to retrieving data from the databases 102, 104.

The computing device 108 is configured to retrieve performance data and operations data from the respective databases using a database management system (“DBMS”) 106. In some implementations, DBMS 106 is a service provided by computing device 108. In another implementations, DBMS 106 can include a relational database system with dedicated storage. In some other implementations, DBMS 106 can include a cloud (e.g., 3rd-party managed and remote) database. DBMS 106 can include relational databases, object databases, key-value databases, and so on. While DBMS 106 is shown as a single entity, in some implementations, DBMS 106 can be implemented as a facility managing distributed data system entities.

The computing device 108 can retrieve or calculate an operations parameter based on the operations data. For example, employee timesheets can be aggregated by the computing device 108 to determine the total number of hours worked in a calendar month. The computing device 108 can also retrieve or calculate a performance metric based on the performance data. For example, payment transactions can be aggregated to determine total revenue for a location in a given calendar week. Performance metrics and/or operations parameters can also be grouped by calendar week, month, day, quarter, etc. For example, employee labor hours and payment transaction revenue can each be aggregated per calendar week. Performance metrics and/or operations parameters can also be grouped based on a custom time period and/or rolling time periods. In alternate implementations, performance metrics and/or operations parameters can be grouped (e.g., aggregated) based on any interval or category.

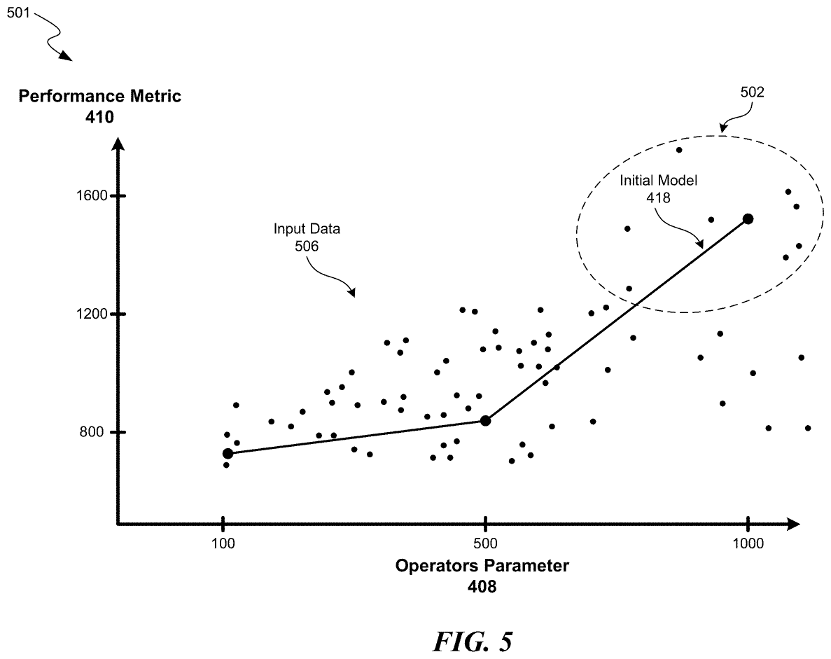

For each location 150, the computing device 108 generates an RCRM 114 using performance data and operations data associated with the location. Generally, RCRM 114 models the relationship between an operations metric (e.g., employee labor hours) and a performance metric (e.g., daily revenue). RCRM 114 is generated based on stored data (e.g., stored historical data, real-time data, training data), including performance data 102 and operations data 104. RCRM 114 uses this historical data to enable the performance of operations decisions to be forecasted. In some implementations, RCRM 114 relates employee labor hours (e.g., operations data) to revenue (e.g., performance data). In other words, RCRM 114 forecasts the value of a performance metric based on the input of an operations parameter. Further, RCRM 114 can be visualized as a plot, as shown in, for example, FIG. 5.

As shown in FIG. 2, the computing device 108 generates the RCRM 114 using a forecasting module 110 and a risk management module 112. The forecasting module 110 generates a set of relationship models (e.g., partial dependency plots or forecasts) based on the operations data and performance data associated with a given location 150.

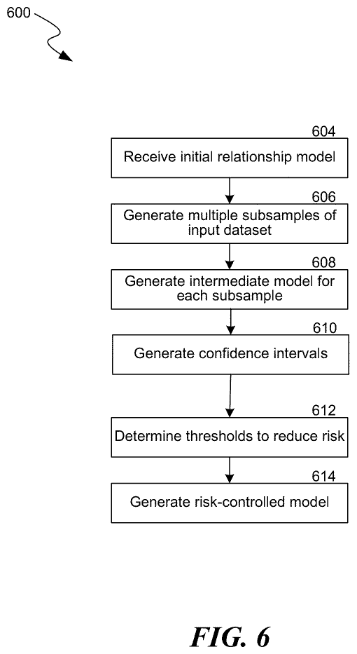

The risk management module 112 accounts for risk associated with increasing an operations parameter. Increasing an operations parameter is usually associated with an increase in cost: increasing the number of employees working over a given time period, for example, increases the labor cost for the time period, and increasing the number of hours a store is open each day increases both labor costs and building maintenance costs (e.g., electrical costs). Thus, risk management module 112 is configured to analyze relationship models to the risk and confidence associated with increasing operations parameters. For example, risk management module 112 can analyze an upper range of an operations parameter to determine the confidence of the associated performance metric projections. If the risk management module 112 detects a region of low confidence, risk management module 112 can adjust or reduce the performance projections for the identified high risk (e.g., high cost) and low confidence (i.e., high statistical variance) operations parameter range. In other words, RCRM 114 can project reduced performance over values of the operations parameter for which the confidence level associated with the model is low. Low confidence can be caused by a reduced number of data points for a particular range of the operations parameter. Additionally or alternatively, low confidence can also be triggered by high variance in the performance data for a particular range of the operations parameter. The operation of risk management module 112 is further described in relation to FIG. 6.

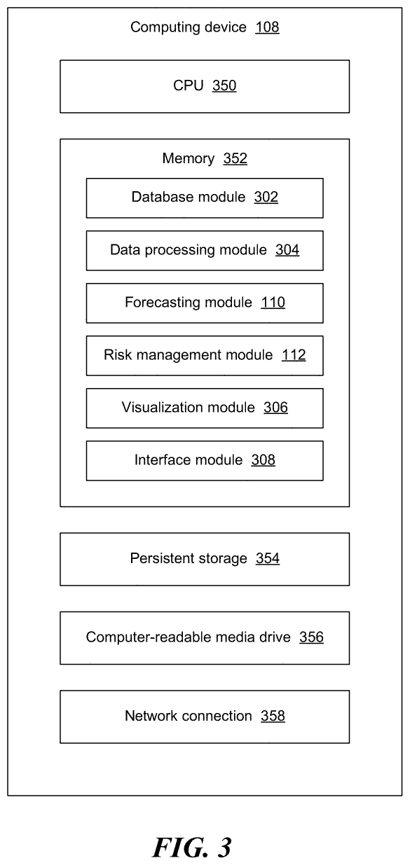

FIG. 3 is a block diagram showing some of the components typically incorporated in at least some of the computer systems and other devices on which the performance optimization system 100 operates. In various implementations, these computer systems and other devices can include server computer systems, desktop computer systems, laptop computer systems, mobile computing devices, smartphones, tablets, etc. In various implementations, the computer systems and devices include zero or more of each of the following: at least one processor (e.g., central processing unit (“CPU”)) 350 for executing computer programs; at least one computer memory 352 for storing programs, data, and/or executable instructions while they are being used, including the recommendation system and associated data, an operating system including a kernel, and device drivers; at least one persistent storage device 354 (also referred to as “memory 354”), such as a hard drive or flash drive for persistently storing programs and data; at least one computer-readable media drive 356 that is tangible storage means that do not include a transitory, propagating signal, such as a floppy, CD-ROM, or DVD drive, for reading programs and data stored on a computer-readable medium; and at least one network connection 358 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the performance optimization system 100, those skilled in the art will appreciate that the performance optimization system 100 can be implemented using devices of various types and configurations, and having various components.

The computing device 108 can implement a number of software modules, stored in memory 352, to facilitate the operation of the performance optimization system 100. In an example implementation, the computing device 108 implements database module 302, data processing module 304, forecasting module 110, risk management module 112, visualization module 306, and interface module 308. These modules are stored in memory 354. In some embodiments, these modules can be distributed across multiple computing devices, such as in a distributed computing system. Additionally or alternatively, software modules can be stored in persistent storage 354, or on network-accessible storage.

Database module 302 is configured to store/retrieve operations data and/or performance data. The database module 302 can interact with one or more database systems, such as local database systems, local mass storage, remote database systems, cloud database systems, distributed database systems, and the like. The database module 302 is configured to generate and execute database queries to retrieve and/or modify performance data and operations data retrieved respectively from the performance database 102 and operations database 104. Performance data and operations data can be stored in the databases as relational database records, key-value records, object-oriented data records, document-oriented data records, etc.

The data processing module 302 is configured to filter, aggregate, group, and otherwise transform performance data and/or operations data. For example, data processing module 302 can be configured to group sales data by store location, or to aggregate sales data by timeframe (e.g., calendar week, month, day). Further, data processing module 302 can be configured to aggregate employee operations data (e.g., timesheets, schedules) to calculate the total worked hours for a specified timeframe. Data processing module 302 can also be configured to filter/aggregate data based on an associated location, such as a retail location or business office.

The visualization module 306 is configured to generate visualizations of relationship models, including risk-controlled relationship models. For example, visualization module 306 can generate a partial dependency plot for a relationship model. Visualization module 306 can be user interactive. For example, visualization module 306 can facilitate a user selecting a portion of a partial dependency plot to enlarge.

The interface module 308 implements a user interface and/or application programming interface (API). In some implementations, interface module 308 is a web application server, configured to provide a web application to client computing devices. The web application can be configured to facilitate the selection of operations parameters and performance metrics and can interact with visualization module 306 to display relationship models. In other implementations, interface module 308 provides an API to the client computing device 116. The client computing device 116 can request relationship models using the API. The API can include a HTTP-based API.

### Embodiments of Forecasting Modules

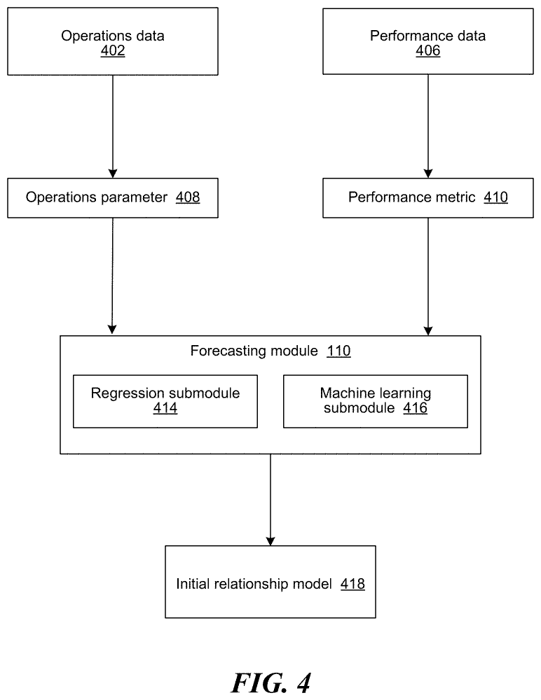

FIG. 4 is a flow diagram showing a process to generate an initial relationship model using the forecasting module 110. Generally, the forecasting module 110 generates relationship model 418 based on received operations data 402 and performance data 406. The operations data 402 includes operations data retrieved from the operations database 104 that is associated with a particular location 150, and optionally that was generated over a specified time period. The performance data 406 includes performance data retrieved from the performance database 102 that corresponds to the operations data 402. For example, the performance data 406 represents a value of a performance parameter measured for each value in the operations data 402.

The forecasting module 110 calculates an operations parameter 408 based on the received operations data 402. The operations parameter 408 generally represents an independent variable that can be controlled through business processes of the location 150. The forecasting module 110 can be configured to aggregate or group operations data 402 to calculate the operations parameter 408. For example, the forecasting module 110 selects all the employees at a particular location and aggregates the total number of hours worked by calendar week. In another example, the forecasting module 110 calculates a total number of operating hours for a location by calendar month.

The forecasting module 110 calculates a performance metric 410 from performance data 406. Generally, the performance metric 410 is a dependent variable, representing a key business performance outcome that cannot be directly controlled. In an example implementation, the performance metric 410 includes aggregate revenue for a particular location by calendar month. In another example implementation, the performance metric 410 includes aggregate transaction volume by week. The forecasting module 110 can aggregate/group performance data 406 to determine the performance metric 410.

The forecasting module 110 is configured to use the operations parameter 408 and the performance metric 410 to generate an initial relationship model 418 to enable the forecasting of future performance of the business associated with the location 150. The initial relationship model is configured to calculate a forecasted performance metric for a given value of the operations parameter.

To generate the initial relationship model 418, the forecasting module 110 can use one or more types of relationship modeling submodules. In the illustrated implementation, the forecasting module 110 executes a regression submodule 414 and machine learning submodule 416. The regression submodule 414 applies mathematical/statistical regression algorithms to the operations parameter 408 and performance metric 410 to generate the initial relationship model 418. For example, regression submodule 414 can implement single linear regression, multiple linear regression, logistic regression, polynomial regression, stepwise regression, ridge regression, lasso regression, etc. The machine learning submodule 416 can use the operations parameter 408 and performance metric 410 as training data to train any combination of artificial neural networks, genetic algorithms, evolutionary programming, or other machine learning models to generate the initial relationship model 418. The forecasting module 110 can have any number of submodules configured to generate relationship model 418 given an independent variable (e.g., operations parameter 408) and a dependent variable (e.g., performance metric 410). In some implementations, forecasting module 110 can be configured to automatically select an appropriate submodule, and/or combine the output of multiple submodules.

FIG. 5 illustrates a plot visualization 501 of the initial relationship model 418. In the illustrated example, the initial relationship model 418 relates employee labor hours to revenue. The visualization 501 also shows example input data 506, representing the values of the performance metric 410 plotted against values of the operations parameter 408. As shown in FIG. 5, the initial relationship model 418 defines a relationship between the value of the performance metric 410 across a range of values of the operations parameter 408, based on an analysis of the historical operations and performance data received by the forecasting module 110.

As illustrated in FIG. 5, the initial relationship model 418 projects high performance for high values of operations parameter 408. On its face, the initial relationship model 418 strongly supports high values of operations parameter 408. However, the costs associated with elevated values of operations parameter 408 can be significant. For example, increasing the number of employees at a location can have a significant and immediate financial cost. Furthermore, because it may be rare for the location 150 to use high values for the operations parameter (e.g., scheduling a large number of employees to work at the same time), the high-performance region of initial relationship model 418—indicated as region 502—is supported by relatively few data points from the input performance and operations data. Overall, region 502 has a number of key characteristics, including (1) high risk associated with elevated levels of operations parameter 408, (2) elevated performance metric projections, and (3) relatively little support from the input data. Overall, region 502 of initial relationship model 418 can improperly influence business decisions, leading to high operations costs and little realized performance.

The computing device 108, through the operation of the risk management module 112, is configured to analytically identify low confidence regions of initial relationship model 418, and to further adjust initial relationship model 418 to control for the risks described above.

The forecasting module 110 may generate any number of initial relationship models for a given location 150. For example, the forecasting module 110 may generate different initial relationship models for different times of year, for different days of the week or weeks in a month, or for different operations or performance parameters.

### Risk Management Module

FIG. 6 is a flow diagram showing a process 600 performed by the risk management module 112 to generate the risk-controlled relationship model 114 (also referred to as “RCRM”).

At block 604, the risk management module 112 receives an initial relationship model, such as the initial relationship model 418 generated by the forecasting module 110. The initial relationship model represents a relationship between performance data and operations data collected from a location 150.

To control for one or more risks modeled in the initial relationship model, the risk management module 112 generates one or more intermediate relationship models based on subsampling of the input data used to generate the initial relationship module. More specifically, at block 606, the risk management module 112 generates multiple subsamples of the retrieved input data. In an example implementation, a bootstrap method is used to generate each subsample. For example, the risk management module 112 randomly selects data points from the input dataset until the subsample has equal size to the input dataset. Each subsample can include a subset of data points from the input data set, with each data point appearing one or more time in the subsample. In other words, data points from the input dataset can be in the subsample any number (e.g., 0, 1, 2+) of times. In some cases, an operator of the computer system 108 can manually remove data points from the input data prior to subsampling. For example, if the input data is associated with a retail store, the operator may remove one or more datapoints corresponding to holiday sales that represent outlier levels of staffing and sales.

After subsampling, at block 608, the risk management module 112 generates an intermediate relationship model (e.g., a partial dependency plot) for each generated data subsample, using the forecasting module 110. This intermediate model is added to a set of generated relationship models, which includes the initial model and other intermediate models generated based on other subsamples of the input dataset.

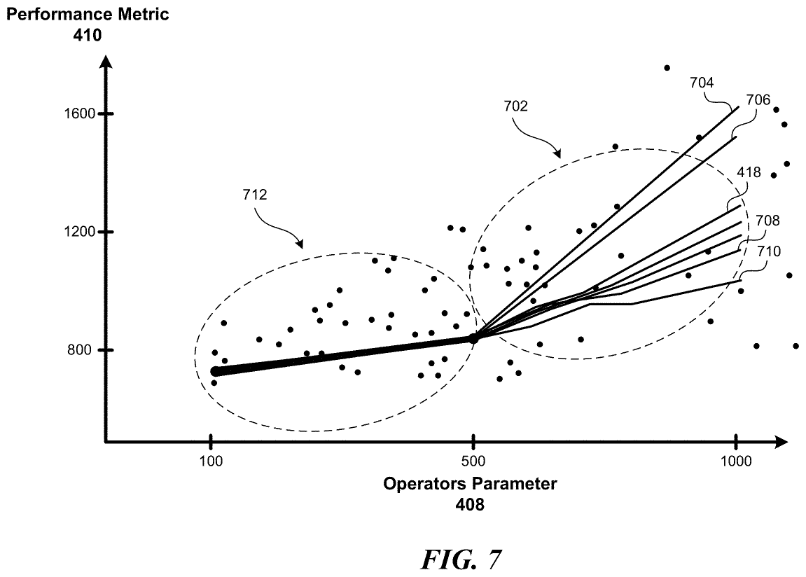

At block 610, the risk management module 112 generates a confidence interval for the initial relationship model based on the multiple intermediate relationship models. Because certain data points can be left out of some of subsamples, the individual influence of an extreme or otherwise irregular data point becomes evident by analyzing the multiple intermediate models together. FIG. 7 shows an example of multiple intermediate relationship models superimposed, illustrating how the intermediate models diverge in regions of low confidence. For example, FIG. 7 illustrates divergence region 702, where a difference between the multiple intermediate relationship models increases. Conversely, for regions where the input data includes a large number of data points, differences between the intermediate relationship models are small and therefore indicative of higher confidence. Accordingly, as illustrated in FIG. 7, the process of subsampling reduces the influence an extreme or otherwise irregular data point can have on the relationship model.

In some implementations, when generating the confidence intervals at block 610, the risk management module 112 segments the operations parameter into predefined intervals based on the multiple intermediate relationship models. For example, labor hours can be segmented into intervals of 700-750 hours, 750-800 hours, 800-850 hours, and so on. In other implementations, the risk management module 112 segments the operations into a predefined number of intervals. For example, an operations parameter ranging from 800-900 can be segmented into 5 intervals. The risk management module 112 can automatically determine an appropriate number of intervals for the operations parameter, based on, for example, a difference between the minimum and maximum values of the operations parameter in the input data or a total number of datapoints in the input data. Further, the intervals selected by the risk management module 112 can have irregular sizes. For example, labor hours can be segmented as 700-775, 775-800, 800-825, 825-900. For each of the determined intervals, the risk management module 112 determines a confidence associated with the interval based on the intermediate relationship models. The confidence of each interval can be determined, for example, by calculating a ratio between values of two or more of the intermediate models within the interval, or by calculating a ratio or difference between slopes of the curves of the intermediate models within the interval.

The risk management module 112 can compare the calculated confidence of a first interval with the confidence of a neighboring intervals. For example, in the illustrated implementation, the confidence of the 700-750 range can be compared with the confidence of the 750-800 range. Additionally, or alternatively, the confidence of multiple ranges can be aggregated/compared. Overall, at least one interval with a confidence below a threshold confidence value is identified as defining a lower bound of the confidence interval for the initial relationship model. For example, the lower bound of the model's confidence interval can be defined as the lower bound of the interval for which the confidence value is below the threshold. However, other values can be selected as the lower bound of the model's confidence interval, such as a value that is a specified amount (e.g., 10%) above or below the lower bound of the interval for which the confidence value is below the threshold.

At block 612, the risk management module 112 generates an operations threshold to reduce risk of the initial relationship model. In response to identifying at least one range with a confidence value below a defined confidence threshold, the risk management module 112 selects an operations threshold. The operations threshold can be a value selected such that it intersects the initial relationship model at or near the lower boundary of a range with low confidence.

In some implementations, the operations threshold can be obtained by back-testing. More specifically, a relationship model can be used to determine the best operations thresholds for accuracy based on historical data (e.g., the input data, operations data, performance data). The risk management module 112 can generate multiple intermediate models, vary the operations threshold, and/or determine which operations threshold(s) give acceptable accuracy (e.g., in terms of profit or cost). In this way the operations threshold is machine learned, in some embodiments.

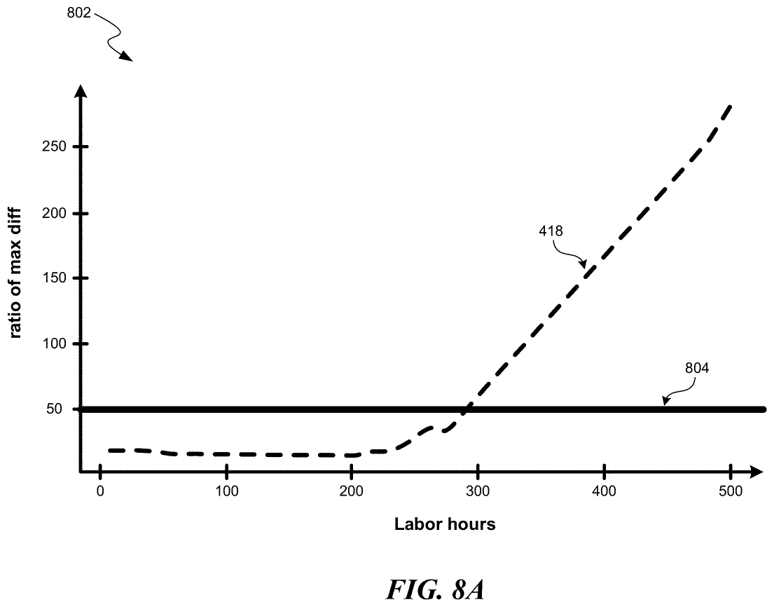

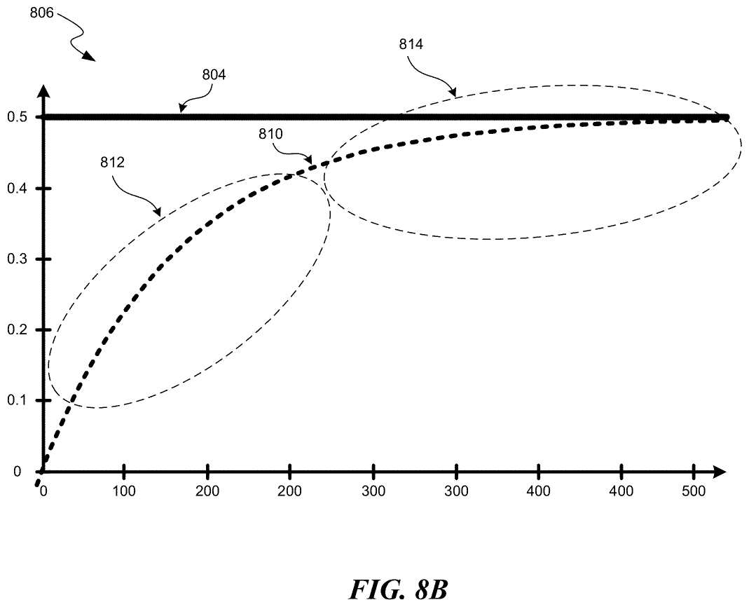

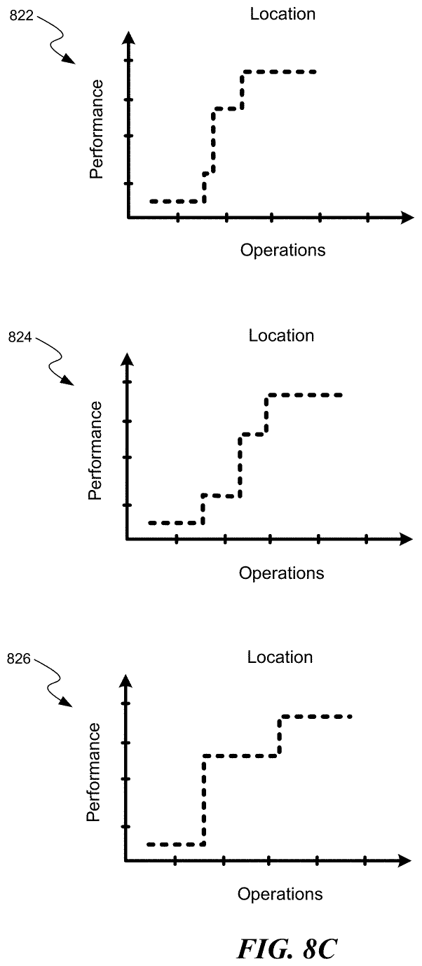

Using the operations threshold, the risk management module 112 modifies the initial relationship model at block 614 to generate the risk-controlled relationship model (RCRM) 114. In some implementations, the risk management module 112 modifies the initial relationship model by using the operations threshold 804 to cap a maximum forecast performance for ranges with low confidence. FIG. 8A is a plot diagram 802 illustrating the initial relationship model 418 superimposed with an operation threshold 804 generated by risk management module 112, where threshold 804 is used as a ‘cutoff’ or ‘cap’ for the initial relationship model 418. Generally, when the RCRM 114 is generated by capping the initial relationship model 418 at the operations threshold 804, the initial model 418 is used to select values of the operations parameter when performance falls below the operations threshold but not used when the desired performance is above the threshold.

In other implementations, the risk management module 112 generates the RCRM 114 by smoothing the initial model based on the operations threshold. FIG. 8B is a plot diagram illustrating a modified relationship model 810 generated by smoothing. Modified relationship model 810 is a stylized plot, where the low confidence region has been mathematically smoothed. High confidence and/or low risk region 812 can be substantially similar to initial relationship model 418. However, low confidence and high-risk region 814 has been mathematically adjusted based on threshold 804. In the illustrated implementation, the end behavior of the relationship model has been modified to be asymptotical with the operations threshold.

FIG. 8C is a plot diagram illustrating a plurality of risk-controlled relationship models, each associated with a different location 150. In some implementation, computing device 108 can be configured to generate an RCRM for each location of a plurality of locations. For example, an RCRM can be generated for multiple retail locations. The computing device 108 can be configured to group operations data and performance data by location. Thus, a common performance metric and operations parameter can be used to analyze data associated with multiple locations. More specifically, payment transactions can be grouped by an associated retail location, and employee timesheets can be grouped by an associated retail location. In the illustrated implementation, the performance data and operations data include data from at least three different locations 150. RCRM plot 822 is associated with a first location, RCRM plot 824 is associated with a second location, and RCRM plot 826 is associated with a third location.

In addition to generating different risk-controlled relationship models for different locations 150, different RCRMs can be generated for the same location. For example, different RCRMs can be generated for different types of operations parameters or performance parameters, or different models can be generated for different times of the year.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations can perform routines having blocks, or employ systems having blocks, in a different order, and some processes or blocks can be deleted, moved, added, subdivided, combined, and/or modified to provide alternative or subcombinations. Each of these processes, message/data flows, or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the methods and system provided herein can be applied to other systems, not necessarily the system described above. The elements, blocks and acts of the various implementations described above can be combined to provide further implementations.

Any patents and applications and other references noted above, including any that can be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system can vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

I/We claim:

1. A method comprising:
accessing sets of operations data and performance data, the operations data representing a plurality of values of an operations parameter collected over a period of time from a retail store and the performance data representing a value of a performance parameter measured for each of the plurality of values of the operations data;
generating based on the sets of operations data and performance data, a risk-controlled relationship model by:
generating based on the sets of operations data and performance data, an initial relationship model predicting a performance metric across a range of operations parameters;
generating multiple intermediate relationship models using each of multiple subsamples of the operations data and performance data;
identifying a confidence interval for the initial relationship model based on a comparison between the initial relationship model and the multiple intermediate relationship models;
selecting an operations threshold using the confidence interval; and
generating the risk-controlled relationship model based on the initial relationship model and the operations threshold; and
selecting a value of the operations parameter for use in the retail store using the risk-controlled relationship model.

2. The method of claim 1, wherein the operations parameter includes employee timesheet data, employee schedule data, mobile device location data, employee assignment data, or retail store operating hours.

3. The method of claim 1, wherein the performance data includes payment transaction data, revenue data, profit data, interaction conversion data, transaction volume data, transaction amount data, or physical traffic data.

4. The method of claim 1, further comprising generating each of the multiple subsamples of the operations data and the performance data by selecting a subset of data points from the operations data and the performance data, where each of the data points in each is selected one or more times.

5. The method of claim 1, wherein identifying the confidence interval comprises:
segmenting the plurality of values of the operations data into multiple intervals;
comparing the multiple intermediate relationship models over each of the multiple intervals to determine a confidence value associated with each of the multiple intervals; and
identifying one or more of the multiple intervals as defining a lower bound of the confidence interval based on the confidence value for the identified interval being less than a specified confidence threshold.

6. The method of claim 5, wherein selecting the operations threshold using the confidence interval comprises selecting a value as the operations threshold that intersects the lower bound of the confidence interval.

7. The method of claim 1, wherein generating the risk-controlled relationship model based on the initial relationship model and the operations threshold comprises capping the initial relationship model at the operations threshold.

8. The method of claim 1, wherein generating the risk-controlled relationship model based on the initial relationship model and the operations threshold comprises smoothing the initial relationship model to an asymptote at the operations threshold.

9. The method of claim 1, wherein the performance data is captured by one or more point of sale devices in the retail store.

10. The method of claim 1, wherein the operations data is captured by one or more Internet of Things devices in the retail store.

11. A non-transitory computer readable storage medium storing executable computer program instructions, the computer program instructions when executed by a processor causing the processor to:
access sets of operations data and performance data, the operations data representing a plurality of values of an operations parameter and the performance data representing a value of a performance parameter measured for each of the plurality of values of the operations data;
generate based on the sets of operations data and performance data, an initial relationship model predicting a performance metric across a range of operations parameters;
generate multiple intermediate relationship models using each of multiple subsamples of the operations data and performance data;
identify a confidence interval for the initial relationship model based on a comparison between the initial relationship model and the multiple intermediate relationship models;
select an operations threshold using the confidence interval; and
generate a risk-controlled relationship model based on the initial relationship model and the operations threshold.

12. The non-transitory computer readable storage medium of claim 11, wherein the sets of operations data and performance data are first sets of operations data and performance data that correspond to a first business with a first physical location and wherein the risk-controlled relationship model is a first risk-controlled relationship model, and wherein the processor is further caused to:
access second sets of operations data and performance data corresponding to a second business with a second physical location; and
generating a second risk-controlled relationship model based on the second sets of operations data and performance data;
wherein the first risk-controlled relationship model and the second risk-controlled relationship model are different.

13. The non-transitory computer readable storage medium of claim 11, wherein the operations parameter includes employee timesheet data, employee schedule data, mobile device location data, employee assignment data, or retail store operating hours.

14. The non-transitory computer readable storage medium of claim 11, wherein the performance data includes payment transaction data, revenue data, profit data, interaction conversion data, transaction volume data, transaction amount data, or physical traffic data.

15. The non-transitory computer readable storage medium of claim 11, wherein the processor is further caused to generate each of the multiple subsamples of the operations data and the performance data by selecting a subset of data points from the operations data and the performance data, where each of the data points in each is selected one or more times.

16. The non-transitory computer readable storage medium of claim 11, wherein identifying the confidence interval comprises:
segmenting the plurality of values of the operations data into multiple intervals;
comparing the multiple intermediate relationship models over each of the multiple intervals to determine a confidence value associated with each of the multiple intervals; and
identifying one or more of the multiple intervals as defining a lower bound of the confidence interval based on the confidence value for the identified interval being less than a specified confidence threshold.

17. The non-transitory computer readable storage medium of claim 16, wherein selecting the operations threshold using the confidence interval comprises selecting a value as the operations threshold that intersects the lower bound of the confidence interval.

18. The non-transitory computer readable storage medium of claim 11, wherein generating the risk-controlled relationship model based on the initial relationship model and the operations threshold comprises capping the initial relationship model at the operations threshold.

19. The non-transitory computer readable storage medium of claim 11, wherein generating the risk-controlled relationship model based on the initial relationship model and the operations threshold comprises smoothing the initial relationship model to an asymptote at the operations threshold.

20. A system comprising:
a database storing operations data and performance data, the operations data representing a plurality of values of an operations parameter and the performance data representing a value of a performance parameter measured for each of the plurality of values of the operations data; and
a performance optimization system comprising a processor and a non-transitory computer-readable medium, the performance optimization system communicatively coupled to the database and configured to apply a risk-controlled relationship model to select an operations parameter for a retail store, the risk-controlled relationship model generated based on the operations data and the performance data and representing a relationship between the operations data and the performance data for values of the operations data that are below an upper threshold selected based on a confidence interval associated with the operations data and the performance data.
